(19) United States
(12) Patent Application Publication
(10) Pub. No.: US 2015/0142647 A1
(43) Pub. Date: May 21, 2015

(54) Consumer Bill-Pay

(71) Applicant: Bank of America Corporation, Charlotte, NC (US)

(72) Inventors: Tyler R. Johnson, Tega Cay, SC (US); Therese H. Willis, Apopka, FL (US)

(73) Assignee: Bank of America Corporation, Charlotte, NC (US)

(21) Appl. No.: 14/168,607

(22) Filed: Jan. 30, 2014

Related U.S. Application Data
(60) Provisional application No. 61/906,710, filed on Nov. 20, 2013.

(51) Int. Cl. G06Q 20/10

(52) U.S. Cl. CPC G06Q 20/102
USPC 705/40

(57) ABSTRACT

A self-service financial transaction device may include a processor and a non-transitory memory communicatively coupled to the processor. The non-transitory memory may be configured to store instructions that, when executed, may cause the processor to request access to a liability account associated with a customer of the financial institution. Upon receiving access to the liability account, the instructions may cause the processor to receive information about a payment received at the self-service financial transaction device that may be applied, at least in part, toward an outstanding balance of the liability account. The processor may then communicate information about the received payment to the financial institution, where the payment may be applied towards an outstanding balance of the liability account.

### CROSS-REFERENCE TO RELATED APPLICATIONS

This application claims priority to U.S. provisional patent application Ser. No. 61/906,710, entitled “Consumer Bill-Pay,” filed Nov. 20, 2013, hereby incorporated by reference as to its entirety.

### TECHNICAL FIELD.

One or more aspects of the disclosure generally relate to computing devices, computing systems, and computer software. In particular, one or more aspects of the disclosure generally relate to computing devices, computing systems, and computer software that may be used by an organization, such as a financial institution or other entity, to allow a user to apply a payment to one or more liability accounts via a self-service financial transaction device.

### BACKGROUND

Customers of a financial institution such as a bank often complete financial transactions through bank tellers or self-service devices, such as automated teller machines (ATMs). After performing the transaction, customers may receive transaction receipts that summarize details of the transaction, such as the type of transaction performed (e.g., a cash withdrawal) and the amount involved. In some cases, a customer may have one or more different accounts associated with the financial institution, which may include one or more savings accounts, checking accounts, consumer credit accounts (e.g., a credit card), and/or liability accounts (e.g., a personal loan, a secured loan, an unsecured loan, and the like). There exists a need to provide the customer, or persons authorized by the customer, to apply a payment to the one or more different liability accounts.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In some cases, a self-service financial transaction apparatus may include a processor and a non-transitory memory communicatively coupled to the processor. The non-transitory memory may include instructions, that when executed, may cause the processor to request access to a liability account associated with the customer of the financial institution. Upon receiving access to the liability account, the self-service financial transaction apparatus may process instructions to receive a payment to be applied towards an outstanding balance of the liability account. The self-service financial transaction apparatus may then process instructions to communicate information about the received payment to the financial institution for application towards the outstanding balance of the liability account.

In other cases, a system may include at least a financial institution computing system and a self-service financial transaction device communicatively coupled to the financial institution computing system, such as by a communications network (e.g., a wide area network (WAN), a local area network (LAN), the Internet, a telecommunications network, and the like). In some cases, the financial institution computing system may include information about a liability account associated with a customer of the financial institution. The self-service financial transaction device may include a user interface a processor and a non-transitory memory device, wherein two or more of the user interface, the processor and the non-transitory memory device are communicatively coupled. In some cases, the user interface may be configured to receive identification information about a user of the self-service financial transaction device. The processor may be configured to process instructions stored in the non-transitory memory that, when executed may cause the processor to request access to the liability account. In some cases, upon receiving access to the liability account, the instructions may cause the processor to receive a payment via the user interface to be applied to the liability account. The instructions, when executed, may further cause the processor to communicate information about the received payment to the financial institution, where the payment may be applied towards an outstanding balance of the liability account.

A method to allow a user of a self-service financial transaction device to apply a payment to an outstanding balance of a liability account may include receiving a request for access to a liability account associated with a customer of the financial institution via a user interface of a self-service financial transaction device. In some cases, the request may include a user identification associated with the liability account. The method may then include presenting, by the user interface of the self-service financial transaction device, information about the liability account to a user at the self-service financial transaction device and receiving a payment via the self-service financial transaction device, for application towards an outstanding balance of the liability account.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented;

FIG. 2 illustrates another example operating environment in which various aspects of the disclosure may be implemented;

FIG. 3 is an illustrative functional block diagram of a self-service financial transaction device (SSFTD) in accordance with at least one aspect of the present disclosure;

FIG. 4 shows an illustrative block diagram of a system for using a self-service financial transaction device in accordance with at least one aspect of the present disclosure;

FIG. 5 shows an illustrative block diagram representation of using customer identification to obtain tiered access to a customer liability account in accordance with at least one aspect of the present disclosure;

FIG. 6 shows an illustrative statement corresponding to a customer liability account;

FIG. 7 illustrates an example of at least a portion of a flow diagram for applying a payment to a customer liability account using a self-service financial transaction device.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

Customers may hold one or more different accounts associated with a financial institution. For example, the financial institution customer may hold one or more direct deposit accounts, credit card accounts and/or liability accounts. Liability account may include one or more of a mortgage, a boat loan, an automobile loan, a home equity loan, and the like. In some cases, the liability account may include one or more reoccurring costs associated with a service and/or function provided by the financial institution. For example, the customer may rent a safety-deposit box, which may have an associated reoccurring cost (e.g., monthly, quarterly, and the like). While a payment may be applied to the one or more different liability accounts, such as by mailing a payment and/or using an online bill-payment system, the customer may desire to apply a payment through a self-service financial transaction device, such as an automated teller machine (ATM).

When the customer obtains authenticated access to an ATM machine, the customer may obtain access to one or more different accounts at the financial institution. For example, the customer may log in using a debit card or other bank-issued card and be presented with information linked to that card. For example, the customer may be prompted, such as during an account setup, to link one or more different accounts to the debit or bank card. In some cases, two or more different DDA accounts may be linked to the customer's card. In other cases, at least one credit card may be linked to the debit card, or a DDA account linked to the card. Once logged in, the customer may be allowed to make a payment to the credit card, such as via a monetary transfer between the linked accounts. However, the customer may not see information about the outstanding balance of the credit card account. In some cases, it may be desirable to present such information to the customer.

Previously, liability accounts, such as the aforementioned liability account types, have not been accessible to the financial institution's customer through a self-service financial transaction device. Further, to make a payment to be applied to these liability accounts, funds were required to be existing and available before processing any payment to the liability account. In other words, the any payments made to the liability account would be required to be processed separately from any activity (e.g., a deposit, a funds transfer, and the like) making funds available for use from a DDA account. In some cases, a customer may only have a liability account (e.g., a home mortgage) at the financial institution, and would therefore not have the ability to link the account to a card for access through a self-service financial transaction device.

Here, systems and methods are described to provide customers of a financial institution with access to liability accounts, via a self-service financial transaction device. In some cases, the customer may access the self-service financial transaction device using one or more different methods, such as by using a card provided by the financial institution, an machine readable code (e.g., a bar code), identification information entered via an input device (e.g., a user name and/or password), and the like. In some cases, the liability account may directly accessible and/or may be linked to one or more different accounts at the financial institution. Upon proper authentication, the customer (or a third-party authorized by the customer) may be allowed to view and/or modify information associated with the liability account. Further, the customer and/or the authorized third-party may be capable of applying a payment to the liability account from the self-service financial transaction device via one or more different methods including a funds transfer from an account, a cash deposit at the self-service financial transaction device, a negotiable instrument deposit (e.g., a check, a money order, and the like) at the self-service financial transaction device and/or a credit card payment (e.g., a cash advance, a credit charge, and the like).

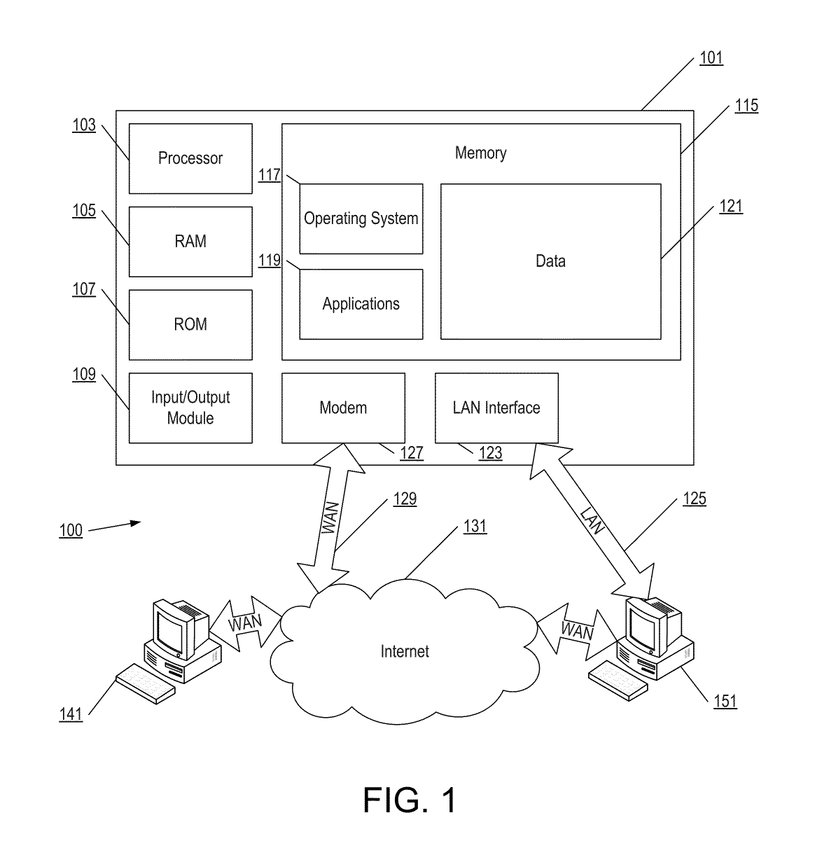

FIG. 1 illustrates an example block diagram of a computing device 101 (e.g., a computer server, desktop computer, laptop computer, tablet computer, other computing devices) in an example computing environment (e.g., system 100) that may be used according to one or more illustrative embodiments of the disclosure. The computing device 101 may have a processor 103 for controlling overall operation of the server and its associated components, including for example random access memory (RAM) 105, read-only memory (ROM) 107, input/output (I/O) module 109, and memory 115.

I/O module 109 may include, e.g., a microphone, mouse, keypad, touch screen, scanner, optical reader, and/or stylus (or other input device(s)) through which a user of computing device 101 may provide input, and may also include one or more of a speaker for providing audio output and a video display device for providing textual, audiovisual, and/or graphical output. Software may be stored within memory 115 and/or other storage to provide instructions to processor 103 for enabling computing device 101 to perform various functions. For example, memory 115 may store software used by the computing device 101, such as an operating system 117, application programs 119, and an associated database 121. Additionally or alternatively, some or all of the computer executable instructions for computing device 101 may be embodied in hardware or firmware (not shown).

The computing device 101 may operate in a networked environment supporting connections to one or more remote computers, such as terminals 141 and 151. The terminals 141 and 151 may be personal computers or servers that include any or all of the elements described above with respect to the computing device 101. The network connections depicted in FIG. 1 include a local area network (LAN) 125 and a wide area network (WAN) 129, but may also include other networks. When used in a LAN networking environment, the computing device 101 may be connected to the LAN 125 through a network interface or adapter 123. When used in a WAN networking environment, the computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed. Computing device 101 and/or terminals 141 or 151 may also be mobile devices (e.g., mobile phones, smartphones, PDAs, notebooks, tablets, other mobile devices) including various other components, such as a battery, speaker, and antennas.

The disclosure is operational with numerous types of general purpose or special purpose computing devices. Examples of well-known computing devices that may be suitable for use with the disclosure (including the system of FIG. 1) include, but are not limited to, desktop computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

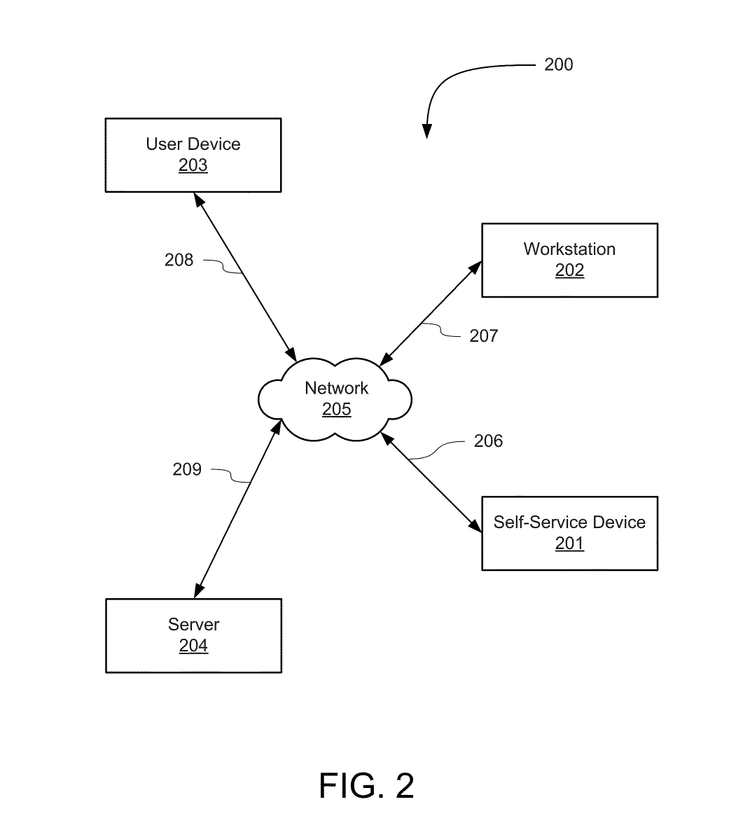

FIG. 2 illustrates an example operating environment in which various aspects of the disclosure may be implemented. An illustrative system 200 for implementing methods according to the present disclosure is shown. System 200 may include one or more self-service devices 201. A self-service device 201 may include, for example, an automated teller machine (ATM), video transaction machine (VTM), a user computing device (e.g., a personal computer, such as a laptop), a mobile device (e.g., a mobile phone, tablet), and other self-service devices. Self-service devices may facilitate transactions and/or communications among a financial institution, users (e.g., customers of the financial institution), and/or third parties (e.g., promotion providers, third-party intermediaries, other third party service and/or product providers) without relying on the services of a bank teller. Self-service devices 201 may be connected by one or more communications links 206 to a network 205.

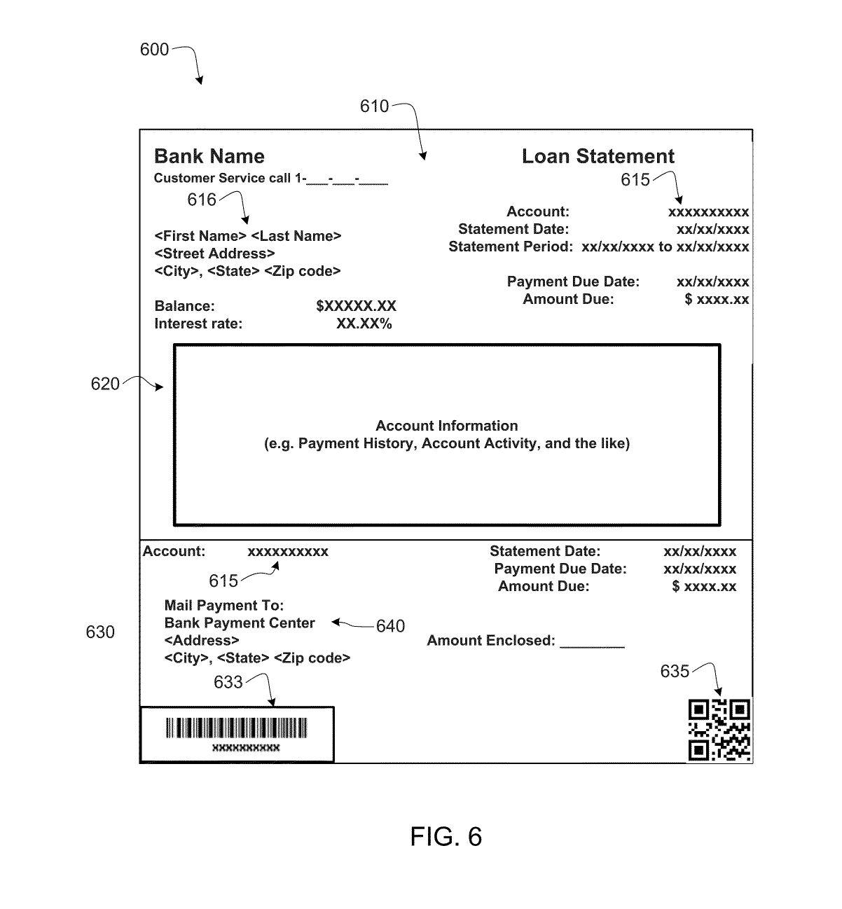

System 200 may include one or more workstations 202. Workstations may include workstations located at financial institution facilities (e.g., a bank) and used by bank employees (e.g., a loan officer, a teller, and the like) to facilitate transactions (e.g., consumer loans, property loans, and the like) requested by customers of the bank. Workstations 202 may be connected by one or more communications links 207 to network 205. The computing environment (e.g., system) 100 may also include one or more user devices 203 (e.g., mobile devices, such as mobile phones, tablets). In some cases, the user devices 203 may include various hardware and/or software components configured to capture images of liability account information from a liability account statement (e.g., the illustrative liability statement of FIG. 6). The user devices 203 may be connected by one or more communications links 208 to the network 205. In some cases, the user devices 203 and the self-service devices 201 may be the same device. For example, a mobile phone may be used as a self-service device to conduct request access to a liability account, to request authorization for a third-party to access the liability account and/or to apply a payment (e.g., an image of a check) towards an outstanding balance of the liability account.

System 200 may also include one or more servers 204, which may be any suitable server, processor, computer, or data processing device, or combination of the same. Servers 204 may be owned, managed, and/or operated by a financial institution. Servers 204 may be connected by one or more communications links 208 to network 205. In some cases, the servers 204 may receive requests from users of a self-service financial transaction device for access to a liability account and/or to apply a payment to the liability account. Furthermore, the servers 204 may store information (e.g., time, date, access tier granted, and the like), user information (e.g., username, account number, personal identification number (PIN), other unique identifiers), and various other information used to process the bill-pay request. Any of the elements in FIG. 2 may be implemented as one or more computing device, such as the example computing device 101 described in connection with FIG. 1.

Network 205 may be any suitable network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), a cellular network, or any combination of any of the same. Communications links 206, 207, 208, and 209 may be any communications links suitable for communicating among self-service devices 201, workstations 202, user devices 203, and/or servers 204, such as network links, dial-up links, wireless links, hard-wired links, other communications links.

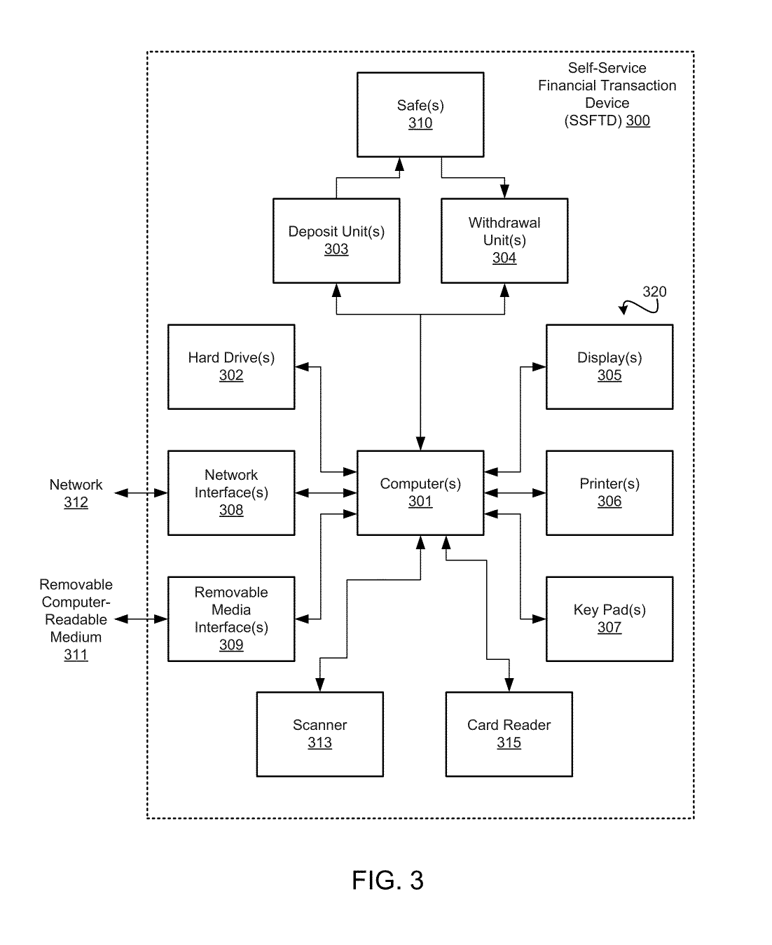

FIG. 3 is an illustrative functional block diagram of a self-service financial transaction device 300. The self-service financial transaction device 300 may include, for instance, an automated teller machine (ATM) or automated kiosk for depositing and/or withdrawing monetary amounts. While the withdrawals are typically provided to the user of the self-service financial transaction device 300 as currency, the deposits may be in the form of currency, checks, images of checks, or other forms.

The self-service financial transaction device 300 as shown in FIG. 3 includes a computer 301, a hard drive 302 or other computer-readable medium, a deposit unit 303, a withdrawal unit 304, a display 305, a printer 306, a key pad 307, a network interface 308, a removable media interface 309, a safe 310, a scanner 313, and a card reader 315. Although computer 301 is labeled as a “computer,” any one or more of the other functional blocks in FIG. 3 may also be or include a processor and/or a computer. As understood, self-service financial transaction device 300 may include one or more computers 301, hard drives 302, deposit units 303, withdrawal units 304, displays 305, printers 306, key pads 307, network interfaces 308, removable media interfaces 309, safes 310, scanners 313, and car readers 315. In some cases, one or more components of the self-service financial transaction device 300 may include, or may include a portion of, a user interface 320 that may include one or more of the display 305, the printer 306, the key pad 307, the scanner 313, the card reader 315, and the like.

The term “computer” as referred to herein broadly refers to any electronic, electro-optical, and/or mechanical device, or system of multiple physically separate or physically joined such devices, that is able to process and manipulate information, such as in the form of data. Non-limiting examples of a computer include one or more personal computers (e.g., desktop or laptop), servers, smart phones, personal digital assistants (PDAs), television set top boxes, and/or a system of these in any combination or sub-combination. In addition, a given computer may be physically located completely in one location or may be distributed amongst a plurality of locations (i.e., may implement distributive computing). A computer may be or include a general-purpose computer and/or a dedicated computer configured to perform only certain limited functions.

A computer typically includes hardware that may execute software and/or be configured in hardware to perform specific functions. The software may be stored on a computer-readable medium in the form of computer-readable instructions. A computer may read those computer-readable instructions, and in response perform various steps as defined by those computer-readable instructions. Thus, any functions attributed to any of the functional blocks of FIG. 3 as described herein may be implemented, for example, by reading and executing such computer-readable instructions for performing those functions, and/or by any hardware subsystem (e.g., a processor) from which the computer is composed.

The term “computer-readable medium” as used herein includes not only a single physical medium or single type of medium, but also a combination of one or more physical media and/or types of media. Examples of a computer-readable medium include, but are not limited to, one or more memory chips, hard drives (e.g., hard drive 302), optical discs (such as CDs or DVDs), magnetic discs, and magnetic tape drives. A computer-readable medium may be considered part of a larger device or it may be itself removable from the device. For example, a commonly-used removable computer-readable medium is a universal serial bus (USB) memory stick that interfaces with a USB port of a device.

A computer-readable medium may store computer-readable instructions (e.g., software) and/or computer-readable data (i.e., information that may or may not be executable). In the present example, a computer-readable medium (such as memory) may be included in any one or more of the functional blocks shown in FIG. 3 and may store computer-executable instructions and/or data used by any of those functional blocks. Alternatively or additionally, such a computer-readable medium storing the data and/or software may be physically separate from, yet accessible by, any of the functional blocks shown in FIG. 3.

Where the self-service financial transaction device 300 is an ATM, computer 301 is typically embodied as a personal computer. In this example, computer 301 may be responsible for the overall control of the self-service financial transaction device 300. To perform such control, computer 301 may execute, for example, one or more software applications, one or more device control programs, and one or more operating systems, each of which may be stored on hard drive 302, which may be a single physical hard drive or multiple physical hard drives. These various elements will be discussed in further detail below.

The hard drive 302 may be a single physical hard drive unit or may include multiple physical hard drive units. Rather than, or in addition to, hard drive 302, the self-service financial transaction device 300 may store data and/or computer-executable instructions on one or more other types of computer-readable medium, such as an optical disc drive, a magnetic tape drive, and/or memory chips.

The deposit unit 303 may be responsible for physically receiving deposited items such as currency and checks, for physically counting the deposited items, for physically holding the deposited items in an escrow area during a deposit transaction, for determining the value of the deposited items, and for physically transferring the deposited items to safe 310 when the transaction is complete. In some cases, the deposit unit 303 may physically receive currency, a check and/or a liability account statement from the user. In some cases, the deposit unit 303 may receive the check and pass the check along to a scanner (e.g., the scanner 313) to generate a scanned image of the check and/or currency and perform character recognition (e.g., optical character recognition, magnetic ink character recognition, and the like) on the currency, the check and/or the liability account statement.

The withdrawal unit 304 may be responsible for physically retrieving currency or other items from the safe 310 during a withdrawal transaction, and for physically providing the retrieved currency to the user.

The display 305 may be responsible for displaying a visual user interface to the user, and may also incorporate a touch screen capability for receiving user input. Typical information that may be presented on the display 305 includes text and/or graphics representing the status of a transaction. Likewise, printer 306 may be responsible for presenting a paper printout containing information about a transaction. The self-service financial transaction device 300 may include a security screen that may visually screen a surveillance device (not shown). The surveillance device may provide video information regarding individuals that are present near the self-service device and regarding the conditions thereabout.

The key pad 307 may include one or more buttons, switches, and/or other physical user input elements, and may be responsible for receiving user input associated with a transaction. For example, the key pad 307 may include digit keys zero through nine and other function keys. The card reader 315 may be any type of device that reads data from a card, such as the magnetic strip on magnetic cards which may include an ATM card, a debit card, a credit card, and the like.

The network interface 308 may be responsible for data communication between the self-service financial transaction device 300 and a network 312. The communication may be unidirectional or bi-directional. The network 312 may be a single network or combination of multiple coupled networks, and may be wireless and/or wired. Examples of the network 312, or portions thereof, include the Internet, a cellular telephone network, a cellular data network, a wired or wireless local area network, and a satellite communication network.

The removable media interface 309 may be responsible for reading from and/or writing to a removable computer-readable medium 311, such as a USB key, a compact disc (CD), a floppy magnetic disc, or a portable hard drive. The removable media interface 309 may therefore include a physical port for plugging in or otherwise temporarily receiving the removable computer-readable medium 311. This port may be physically part of, for instance, the housing of the computer 301. However, the port may be located elsewhere in or on the self-service financial transaction device 300, such as on a rear housing of the self-service financial transaction device 300 that may be accessible to maintenance servicers of the self-service financial transaction device 300 but not necessarily to the general public. Regardless of the location of the port, data read from the removable computer-readable medium 311 by the removable media interface 309 may be provided to the computer 301, and data provided by the computer 301 may be written by the removable media interface (e.g., I/O module 109) to the computer-readable medium 311.

The scanner 313 may include, for instance, a camera that is able to take a digital photograph of a check to produce one or more images representing the front and/or back of the check. In some cases, the scanner 313 may include a processor configured to perform character recognition (e.g., optical character recognition) based on the image taken by the camera. In addition to generating an image of the check, the scanner 313 may include a magnetic reader (e.g., a magnetic read head) and be further capable of reading magnetically printed information on the check, such as magnetic ink that is typically printed on a check, and performing magnetic ink character recognition (MICR). The data produced by performing MICR that represents the recognized magnetic ink characters is referred to herein as MICR data. The scanner 313 further may be configured to capture an access code as described herein. The access code may be a barcode printed on a paper ticket. The paper ticket may be scanned to read the barcode included. The access code also may be a barcode displayed on a mobile device, such as a cellular telephone. A user may place the display of the mobile device in the scanning field of view of the scanner 313 and the barcode may be read there from without the need for a paper ticket. The scanner 313 also may be configured to read a radio frequency identification (RFID) associated with a card, a mobile device, and/or some other apparatus of an individual.

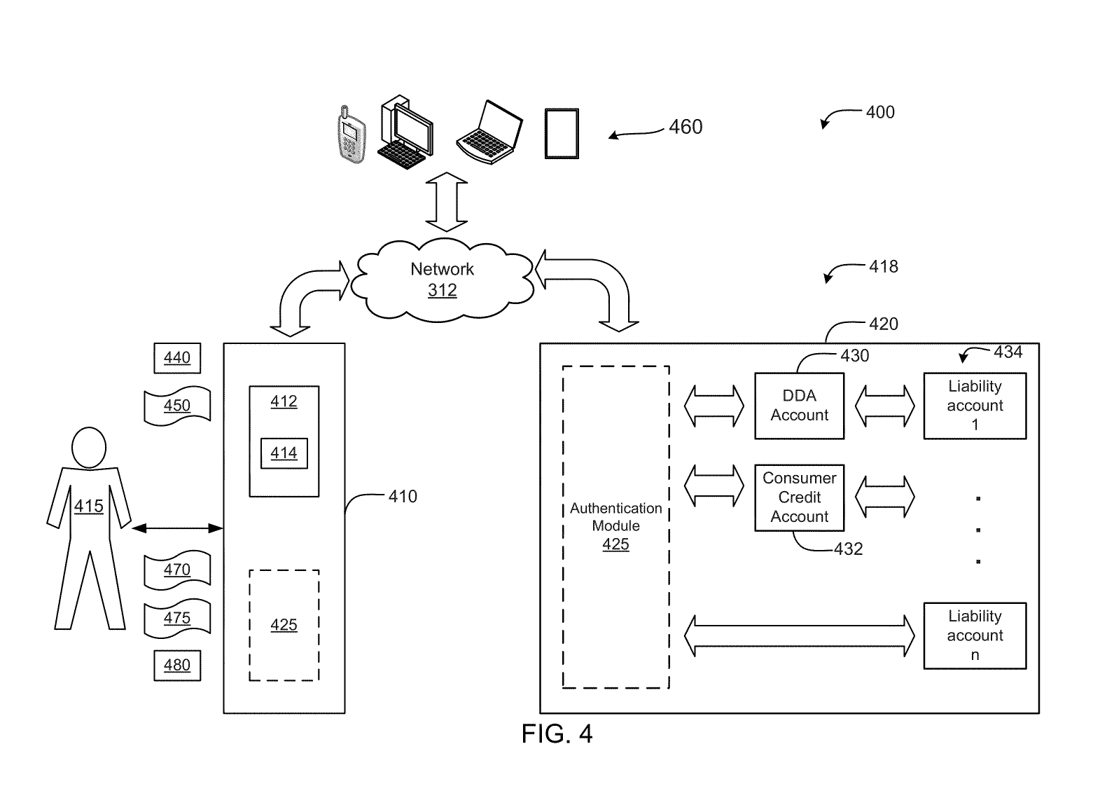

FIG. 4 shows an illustrative block diagram of a system 400 for using a self-service financial transaction device 410 in accordance with at least one aspect of the present disclosure. The illustrative system 400 may include a self-service financial transaction device 410 (e.g., the self-service financial transaction device 215, 300) that may be used by a user 415 to obtain access to one or more financial accounts associated with the user. For example, the self-service financial transaction device 410 may be communicatively coupled via the network 312 to a computing system associated with the financial institution, such as the financial institution computing system 420. The financial institution computing system 420 may include an authentication module 425 that may be used to authenticate user information before allowing access by the user 415 to any financial accounts associated with the user, such as one or more demand deposit accounts (DDA) 430 (e.g., a savings account, a checking account, and the like), one or more consumer credit accounts 432 (e.g., a credit card), and one or more liability accounts 434 that each may correspond to a loan associated with the user. For example, one or more of the liability accounts may be associated with a secured loan (e.g., a mortgage, an equity loan, a car loan, a boat loan, an airplane loan, and the like), an unsecured loan (e.g., a personal loan, a line of credit, a bank overdraft, and the like), a demand loan, a subsidized loan, a concessional loan, and/or another loan type.

The user 415 may be a customer of financial institution 418 and/or a person authorized by the customer of the financial institution. For example, the user 415 may authorize a third-party to apply a payment via the self-service financial transaction device 410. In some cases, the customer may authorize the third-party by accessing the financial institution computing system 420 via the network 312 using one or more computing devices 460 (e.g., a computer, a laptop, a tablet computer, a telephone, a smart phone and the like). In some cases, one or more computing devices 101 on the financial institution computing system 420 may be configured to authorize a third-party to access the liability account 434 associated with the user 415 upon receiving a request via the network 413. For example, the user 415 may authorize the third-party to apply a payment to be applied towards an outstanding balance of the liability account. Upon receiving the request, the computing device 101 may provide identifying information to be used to identify the third-party as being authorized to access a particular liability account 434. For example, the financial institution computing system 420 may provide media storing the authorization information (e.g., a bank card, an identification card), an authorized user name that may be entered via a user interface 412 of the self-service financial transaction device 410, or the like.

In some cases, the user 415 may use the self-service financial transaction device 410 to request access to one or more liability accounts 434, such as a personal loan and/or a mortgage loan, such as to apply a payment to an outstanding balance. For example, the user 415 may enter identification information that was associated with that particular user 415 by the financial institution 418. The identification information may include one or more of information encoded on a magnetic media, such as a magnetic strip on a card 440 (e.g., a credit card, a debit card, a bank card, or the like), information (e.g., a bar code, a two dimensional bar code, a quick response (QR) code, and the like) printed on a media 450 (e.g., an account statement, a letter, and the like), or information entered via the user interface 412 (e.g., a user name, a user number, an authentication code, and the like), information stored on an radio frequency identification (RFID) device.

In some cases, the user 415 may not have a DDA account at the financial institution 418. For example, the user 415 may have one or more of a consumer credit account 432 (e.g., a credit card) and/or one or more liability accounts 434 (e.g., a car loan, a home mortgage, a boat loan, a personal loan, and the like). In such cases, the financial institution 418 may allow a user access to the self-service financial transaction device 410 using a credit card 440 tied to the consumer credit account 432, a bank card 440 (e.g., an ATM card) associated with one or more of the consumer credit account 432 and the one or more liability accounts 434, and/or a user identification (e.g., a user name, a user number, and the like), each associated with authentication information (e.g., a PIN, a verification code, and the like).

In some embodiments, the self-service device 410 may include a biometric sensor (not shown). The biometric sensor may identify a customer based on a feature, such as an anatomical feature, of the customer. For example, the biometric sensor may be configured to identify the customer based on all or part of a face, a fingerprint, an iris, a retina a hand or any other suitable anatomical feature. The biometric sensor may identify the customer based on a behavioral feature such as a signature, a voice, a gait or any other suitable behavioral feature. In some of these embodiments, information received by the biometric sensor may be used, in conjunction with PIN input and user fingerprint information, to validate the identity of the user. In some cases, the biometric sensor may include an iris scanner. In some of these embodiments, a camera built into an ATM may be used as an iris scanner and authentication may require a sequence of fingerprints, an input PIN and/or an iris scan, as described in the commonly assigned U.S. Patent Publication No. 2013/0264384, entitled “Automatic Teller Machine (“ATM”) Including a User-Accessible USB Port,” the contents of which are incorporated herein by reference in its entirety for any and all non-limiting purposes.

Upon entry of the identification information, the user 415 may enter associated authentication information before receiving authorization to access one or more accounts (e.g., the DDA account, the consumer credit account 432, one or more liability accounts 434, and the like). The self-service financial transaction device 410 may prompt the user to enter the identification information via a user interface screen. In some cases, the self-service financial transaction device 410 and/or the financial institution computing system 420 may include an authentication module 425. For example, the authentication module 425 may be configured to receive an authentication code (e.g., a PIN, a pass code, a pass word, and the like) from the user 415. In some cases, the authentication module 425 may be implemented using on or more computing devices 101 as part of the financial institution computing system 420, as part of the self-service financial transaction device 410, or a combination.

Upon successful authorization of the user 415 at the self-service financial transaction device 410, the user 415 may be permitted to access to one or more accounts associated with the authorized user identification information. In some cases, one or more of the accounts may be linked to the user identification. For example, a particular card 440 (e.g., a bank card, a debit card, or the like) may be linked to at least one DDA account associated with the user, such as a savings account or a checking account. In some cases, a user 415 may associate one or more different accounts with the card 440. For example, the user 415 may associate the consumer credit account 432 or one or more of the liability accounts 434 with the debit card. In such cases, one or more of the consumer credit account 432 or the liability accounts 434 may similarly linked to one or more different accounts, such as the DDA account 430. For example, a user may desire to associate a liability account 434 (e.g., a personal loan, a student loan, a car loan, a mortgage, and the like) to a DDA account 430, such that a payment may be applied against an outstanding balance of the liability account 434 directly from the DDA account. In some cases, the user 415 may desire to link the liability account 434 to the consumer credit account 432, such that a payment may be applied against an outstanding balance of the liability account 434. For example, the user 415 may apply a payment towards the outstanding balance of the liability account 434 using a credit and/or debit card.

In some cases, the user 415 may be able to associate one or more liability accounts 434 to the DDA account 430 and/or the consumer credit account 432 using the self-service financial transaction device 410. For example, upon proper authentication, the self-service financial transaction device 410 may present a user interface screen presenting one or more of the liability accounts 434 that may be linked to one or more available DDA accounts and/or consumer credit accounts. The user 415 may then select which of the one or more different liability accounts to be linked to a particular DDA account 430 and/or a particular consumer credit account 432. For example, the user 415 may desire to link a home mortgage and/or a car loan to a checking account, a boat loan and/or a second mortgage to a savings account, a personal loan to a particular credit card, and/or a student loan to the checking account and the credit card. These examples are merely illustrative and are not meant to be limiting. For example, any particular liability account 434 may be linked to any DDA account 430, any consumer credit account 432, or any combination of accounts.

In some cases, the user 415, when authenticated, may be capable of depositing, withdrawing, and/or transferring funds between two or more different accounts. For example, the user 415 may be capable of depositing money into one or more DDA accounts using the deposit unit 403. In some cases, the user 415 may be capable of depositing funds (e.g., cash, a check, and the like), such as to apply a payment towards the consumer credit account 432, as described in in the commonly assigned U.S. patent application Ser. No. 12/786,389, published as U.S. Patent Publication No. 2011/0288999, and entitled “Deposit Permissions for Specific Non-Account Holders,” the contents of which are incorporated herein by reference in its entirety for any and all non-limiting purposes. The user 415, when authenticated, may be capable of applying a payment towards the outstanding balance of the one or more liability accounts 434 via the self-service financial transaction device 410. For example, the user 415 may be presented with a screen (e.g., a payment screen 414) at the user interface 412 of the self-service financial transaction device 410 that may allow the user 415 to apply a desired payment amount towards the outstanding balance of a selected liability account. The payment screen 414 may present the user 415 with one or more options for making the payment at the self-service financial transaction device 410. The options may include making a payment using one or more of a linked account (e.g., the DDA account 430, the consumer credit account 432, and the like), a credit card payment 480 including at least one of a credit card, a debit card, a gift card, and the like, a cash deposit 470, a negotiable instrument deposit 475 (e.g., a check). In some cases, the payment screen 414 may provide an option to directly apply a payment (e.g., a cash deposit 470, a negotiable instrument deposit 475, a credit card payment 480) and/or a combination of payments directly towards the outstanding balance of one or more liability accounts. In some cases, the payment screen 414 may present an option to the user 415 to apply a portion of a payment made and/or deposited at the self-service financial transaction device 410 towards the outstanding balances of two or more different liability accounts 434. For example, a user may deposit a cash deposit 470 and/or a negotiable instrument 475 using the deposit unit 303 of the self-service financial transaction device 410, where a first portion of the deposit is directed towards the outstanding balance of a first liability account (e.g., a car loan) and a second portion of the deposit towards the outstanding balance of a second liability account (e.g., a home mortgage). In some cases, the user may use the payment screen 414 to facilitate a payment towards the outstanding balance of a liability account using two or more different payment sources. For example, a user may desire to apply a cash deposit 470 towards a first portion of the outstanding balance of the liability account 434, a negotiable instrument deposit 475 towards a second portion of the outstanding balance and/or a credit card payment 480 towards a third portion of the outstanding balance. In some cases, the payments received at the self-service financial transaction device 410 may be made in real-time. In other cases, one or more payments may be held for a duration pending verification.

Upon receipt and/or verification of the payment received from the user 415, the self-service financial-transaction device 410 may communicate the payment information to the financial institution computing system 420, such as via the network 312. In some cases, the financial institution 418 may desire to verify the authenticity of the one or more payments before applying a credit to the liability accounts. Payment authentication functionality may be implemented within the self-service financial transaction device 410, a computing device 101 within the financial institution computing system 420, or both. For example, the self-service financial transaction device 410 may be configured to hold the cash deposit 470 when a denomination of the deposited currency is greater or equal to a specified denomination and/or when the total currency deposit is greater than a specified amount. When a negotiable instrument 475 is deposited, the payment may be held if the amount of the check is greater than a specified amount and/or when the negotiable instrument is drawn against an account associated with a different financial institution. Sometimes, the user 415 may electronically deposit a check by providing an image of the check to the self-service financial transaction device 410, such as by using the scanner 313 and/or transferring an image captured using a user device 460. In some cases, the self-service financial transaction device 410 may be configured to verify that the check has not been deposited at a different location and/or method, such as by requesting information about the check and/or the account associated with the check, from the financial institution computing system 420.

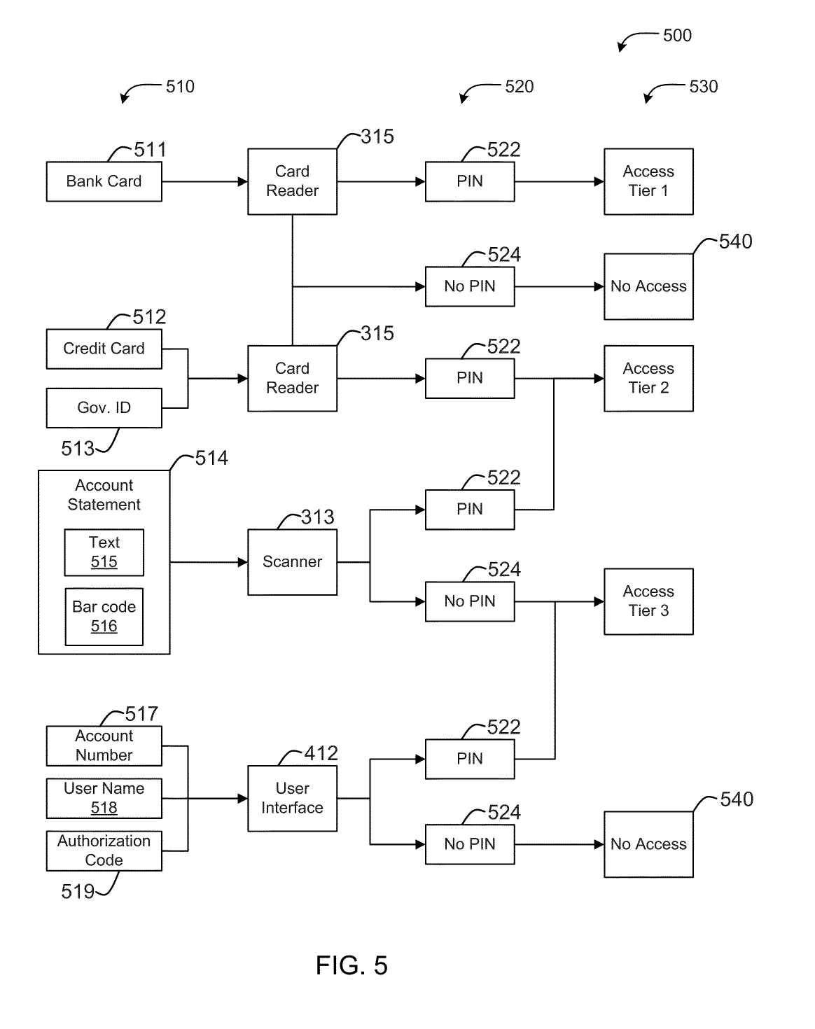

FIG. 5 shows an illustrative block diagram representation of user identification 510 used to obtain tiered access to one or more customer liability accounts 434 in accordance with at least one aspect of the present disclosure. In some cases, the system 500 may be configured to determine an access level (e.g., access tier 1, access tier 2, access tier 3, and the like). In some cases, the access tier 530 for a particular user 415 of the self-service financial transaction device 410 may be determined by the type of user identification 510 and/or authentication information 520. For example, the user 415 may provide particular user identification 510 provided by the financial institution 418 for use in accessing one or more user accounts via the self-service financial transaction device 410. Such user identification 510 may include a bank card 511 (e.g., an ATM card, a bank card, a debit card, an RFID device, and the like). In some cases, a customer of the financial institution 418 may associate different user identification 510 with one or more liability accounts, such as a credit card 512 and/or a government issued identification 513 (e.g., a driver's license, a state identification card, a passport, and the like). In some cases, the user identification 510 may include at least a portion of an account statement 514 of a liability account 434, such as text 515 and/or a bar code 516. In some cases, the user identification may include one or more of an account number 517, a username 518 and/or an authorization code 519. For example, the self-service financial transaction device 410 may include a user interface screen that allows a user to enter the account number 517 of a particular liability account 434. In some cases, the financial institution 418 may provide a user name 518 and/or an authorization code 519 to a customer and/or a third-party authorized by the customer, where the user name 518 and/or the authorization code 519 may be entered via the user interface screen.

In some cases, the user 415 may swipe, or insert a card into the card reader 315 to initiate a transaction on the self-service financial transaction device. In some cases, the user 415 may scan (not shown) at least a portion of a government ID (e.g., a driver's license, a passport, a state ID card, and the like) to initiate the transaction. For example, the self-service financial transaction device 410 may read user identification 510 from a magnetic media associated with the card 511, 512 and/or from a portion of the scanned government issued identification. Upon processing the user identification 510, the user may be prompted to enter authentication information (e.g., a PIN 522) at the user interface 412 of the self-service financial transaction device. The authentication module 425 may then process the user identification 510 and the PIN 522 to determine an access tier to be granted to the user 415. For example, for bank issued identification, such as the bank card 511, the user may receive full access to liability account information (e.g., access tier 1). In such cases, the user may be allowed to make a payment, view account information (e.g., customer contact information, account activity information, and the like), modify account information, associate one or more accounts (e.g., the DDA account 430, the consumer credit account 432) to the liability account 434 and/or authorize a third-party to apply a payment to the liability account 434. When non-bank issued identification (e.g., the credit card 512, the government issued identification 513) is properly authenticated, the user 415 may receive second tier access (e.g., access tier 2) to the liability account 434. In such cases, the user 415 may be allowed to make a payment to an account and/or view selected account information. The selected account information may include at least a portion of the information presented to the customer on an account statement 600, such as the account statement 600 of FIG. 6. If, however, the user identification is not properly authorized, the user may receive no access 540 to the liability account.

In some cases, the user 415 may scan at least a portion of the account statement 514 using the scanner 313. In some cases, the scanner 313 may be configured to scan at least a portion of the account statement 600 externally to the self-service financial transaction device 410. For example, the scanner may be used to scan text 515 (e.g., customer contact information, an account number, and the like) and/or a bar code 516. Upon proper authentication of the scanned user identification 510 by the authentication module 425, the user may be granted partial access (e.g., access tier 2) to the liability account 434, such that the user 415 may apply a payment towards the balance of the liability account and/or view selected account information. In some cases, if the account statement 514 is not properly authenticated, the user may be granted low level access (e.g., access tier 3) to the liability account 434. In such cases, the user may be allowed to apply a payment towards an outstanding balance and/or view at least a current payment amount due on the liability account 434. In other cases, if the information scanned from the account statement 514 is not properly authenticated, the user may receive no access 540 to the liability account.

In some cases, the user 415 may enter the account number 517 of the liability account 434 or a user name 518 and/or an authorization code associated with the liability account 434. In some cases, one or more different user names 518 and/or authentication codes 519 may be associated with the liability account 434, where different access levels may be associated with each of the different user names and/or authorization codes. For example, the account holder may be issued a first user name 518 or first authorization code 519, and a third-party may be issued a second different user name 518 or second authorization code 519. The account holder, upon proper authentication of the first user name 518 or first authorization code 519, may receive higher level access (e.g., access tier 1 or access tier 2) to the liability account 434. A properly authorized third-party may receive lesser access (e.g., access tier 3) to the liability account 434. Sometimes, however, the properly authorized third-party may receive higher level access (e.g., access tier 1 or access tier 2) to the liability account 434. If the entered account number 517, the user name 518 or the authorization code 519 is not properly authenticated, the user 415 may receive no access 540 to the liability account 434.

FIG. 6 shows an illustrative account statement 600 (e.g., the account statement 514) corresponding to a customer liability account 434. The illustrative account statement 600 may include an account information portion 610, an account activity portion 620, and/or a payment portion 630. The account statement 600 may be used to inform customers of the status of their account and/or to solicit payment towards the outstanding balance of the account. For example, the account information portion may include customer contact information 616 that may include a customer name, a customer address and/or a customer phone number. In some cases, the account statement 600 may include an account number 625 associated with the liability account 434. The account information portion may also include one or more of a statement date, a statement period, a payment due date, a payment amount, an outstanding balance amount, an interest rate, or the like. The Account activity portion 620 may include a payment history of the account and/or account activity during the current statement period and/or previous statement periods. The payment portion 630 may be used to facilitate deliver and/or processing of a payment towards the outstanding balance of the liability account 434. The payment portion may include an address associated with the financial institution 640, the account number 615, a payment due date, a statement date and/or an amount currently due on the account by the particular payment due date. In some cases, the payment portion may include one or more of a bar code 632 and/or a two-dimensional bar code (e.g., the QR code 635). The bar code 632 and/or the QR code 635 may be used by the financial institution 418 to facilitate processing of a payment made in response to the account statement 600. In some cases, the account number 615, the customer contact information 616, the bar code 633, the QR code 635 may be scanned by the self-service financial transaction device 410 to at least partially identify a user 415 desiring to access the associated liability account 434, as described above.

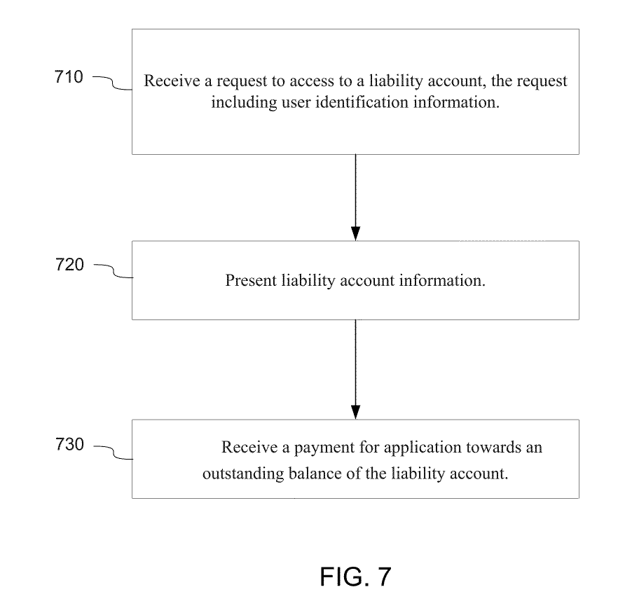

FIG. 7 illustrates an at least a portion of an illustrative flow diagram 700 for applying a payment to at least one customer liability account 434 using a self-service financial transaction device 410. Some or all of the steps illustrated in FIG. 7 may be partially or fully performed by a computing device that may be owned, managed, and/or operated by a financial institution, such as the self-service financial transaction device 410. In step 710, the self-service financial transaction device 410 may receive a request for access to one or more liability accounts 434 associated with a customer of the financial institution (e.g., the user 415) via at least a portion of a user interface (e.g., a keypad, a touch screen, and the like) of the self-service financial transaction device 410, the request including a user identification 510 associated with the liability account 434. At 720, the user interface 412 of the self-service financial transaction device 410 may present information about the liability account to a user at the self-service financial transaction device 410. At 720, the self-service financial transaction device 410 may receive a payment 480, 490 from the user 415 for application towards an outstanding balance of the liability account 434.

In some cases, the self-service financial transaction device may be configured to receive authentication information from an authentication device (e.g., the authentication module 425) of a financial institution computing system 420. Upon proper authentication of the user identification, the self-service financial transaction device 410 may provide access to information associated with the liability account 434 according to one or more different access tiers 530. The access tiers 530 may be based, at least in part, on the particular type of authenticated user identification information used to access the liability account 434. In some cases, the self-service financial transaction device 410 and/or the financial institution computing system 420 may be configured to authorize third-party user access of the liability account 434. For example, third-party user identification may be associated with the liability account 434 by the customer associated with the liability account 434 using one via a user device 460 communicating with the financial institution computing system 420.

The self-service financial transaction device 410 may receive a payment towards the outstanding balance of the liability account by receiving at least one of a cash deposit at an input of the self-service financial transaction device, a negotiable instrument at the input of the self-service financial transaction device, and/or an image of the negotiable instrument using the scanner 360. Upon receiving the payment, the self-service financial transaction device may apply the payment received at the self-service financial transaction device 410 toward the outstanding balance of the liability account 434. In some cases, at least a portion of the payment received is applied towards the balance in real-time. In some cases, the payment may be held for a duration based on at least one of an amount of the payment, a currency denomination received by the deposit unit 303, a determination whether a check image was deposited at a different location, and/or based upon a determination based upon one or more other business rules.

Various aspects described herein may be embodied as a method, an apparatus, or as computer-executable instructions stored on one or more non-transitory and/or tangible computer-readable media. Accordingly, those aspects may take the form of an entirely hardware embodiment, an entirely software embodiment (which may or may not include firmware) stored on one or more non-transitory and/or tangible computer-readable media, or an embodiment combining software and hardware aspects. Any and/or all of the method steps described herein may be embodied in computer-executable instructions stored on a computer-readable medium, such as a non-transitory and/or tangible computer readable medium and/or a computer readable storage medium. Additionally or alternatively, any and/or all of the method steps described herein may be embodied in computer-readable instructions stored in the memory and/or other non-transitory and/or tangible storage medium of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A self-service financial transaction apparatus, the apparatus comprising:
a deposit unit for receiving a deposit from the at the self-service financial transaction apparatus;
a processor;
a non-transitory memory communicatively coupled to the processor and storing instructions, that when executed by the processor, cause the apparatus to:
receive access to a liability account associated with a financial institution;
after receiving access to the liability account, receive a payment to be applied towards an outstanding balance of the liability account using the deposit unit; and
communicating payment information to the financial institution, the payment information including an amount to be applied towards the outstanding balance of the liability account.

2. The self-service financial transaction apparatus of claim 1 comprising a user interface communicatively coupled to the processor and the memory, the user interface including:
an input receiving user identification information;
a first screen to receiving authentication information; and
a second screen, upon proper authentication, for displaying information about the liability account.

3. The self-service financial transaction apparatus of claim 2, wherein the input includes a card reader for reading user identification information from a card.

4. The self-service financial transaction apparatus of claim 3, wherein the card comprises one of a debit card, and an automatic teller machine card.

5. The self-service financial transaction apparatus of claim 4, wherein the card reader is adapted to accept a credit card, wherein the credit card is associated to the liability account.

6. The self-service financial transaction apparatus of claim 1, comprising a scanner adapted to obtain an image of a statement associated with the liability account, wherein the image of the statement provides user identification information.

7. The self-service financial transaction apparatus of claim 1, wherein receiving access to the liability account includes:
receiving user identification information; and
authenticating the user identification information using authentication information received from a user of the self-service financial transaction apparatus.

8. The self-service financial transaction apparatus of claim 7, wherein the identification information is encoded on a magnetic media and includes at least one of customer information and customer account information.

9. The self-service financial transaction apparatus of claim 7, wherein the identification information is obtained from at least a portion of a scanned image, the portion of the scanned image including a bar code.

10. The self-service financial transaction apparatus of claim 9, wherein the bar code includes a two-dimensional bar code.

11. The self-service financial transaction apparatus of claim 1, wherein receiving access to the liability account includes:
obtaining a scanned image of at least a portion of a liability account statement; and
requesting authentication information based on user identification information obtained from the scanned image via optical character recognition.

12. The self-service financial transaction apparatus of claim 1 further comprising receiving access to the liability account, wherein access to the liability account corresponds to one or more access tiers.

13. The self-service financial transaction apparatus of claim 12, wherein receiving access to the liability account includes receiving first tier access to liability account after proper authentication of financial institution issued user identification.

14. The self-service financial transaction apparatus of claim 13, wherein financial institution issued identification includes at least one of encoded information stored on electronically readable media and a character based user identification entered via a user interface.

15. The self-service financial transaction apparatus of claim 13, wherein first tier access includes access to a majority of customer liability account information including, one or more of a current amount due, a previous payment amount, a balance amount an account number, customer identification information, and customer correspondence information.

16. The self-service financial transaction apparatus of claim 12, wherein receiving access to the liability account includes receiving second tier access to liability account information after proper authentication of liability account information obtained via a user interface of the self-service financial transaction apparatus.

17. The self-service financial transaction apparatus of claim 16, wherein the liability account information includes at least one of information obtained from a scanned image of at least a portion of a liability account statement and a customer liability account number obtained from the user interface.

18. The self-service financial transaction apparatus of claim 16, wherein second tier access includes access to at least a portion of information available on a liability account statement.

19. The self-service financial transaction apparatus of claim 12, wherein receiving access to the liability account includes receiving third tier access to liability account information after proper authentication of third-party issued identification associated with the liability account.

20. The self-service financial transaction apparatus of claim 19, wherein third-party issued identification includes at least one a third-party issued credit card and a government issued identification.

21. The self-service financial transaction apparatus of claim 19, wherein third tier access includes access to a minimum of customer liability account information including at least a current payment amount due on the liability account.

22. The self-service financial transaction apparatus of claim 1, further comprising receiving a payment to be applied to the liability account using the deposit unit.

23. The self-service financial transaction apparatus of claim 22, wherein the payment received using the deposit unit includes at least one of a cash deposit, a negotiable instrument deposit, and a credit card payment.

24. The self-service financial transaction apparatus of claim 23, wherein the negotiable instrument deposit includes a scanned image of a negotiable instrument.

25. A system comprising:
a financial institution computing system including liability account information associated with a customer of the financial institution;
a self-service financial transaction device communicatively coupled to the financial institution computing system, the self-service financial transaction device including:
a user interface;
a processor communicatively coupled to the user interface; and
a non-transitory memory communicatively coupled to the processor and the user interface, the non-transitory memory storing instructions, that, when executed, cause the processor to:
request access to the liability account;
upon receiving access to the liability account, receive a payment via the user interface, the payment to be applied to the liability account; and
communicate payment information to the financial institution for application towards an outstanding balance of the liability account.

26. The system of claim 25, wherein the financial institution computing system includes a computing device receiving user identification information and authenticating the user identification information before allowing access to the liability account via the self-service financial transaction device.

27. The system of claim 25, wherein the non-transitory memory of the self-service financial transaction device includes instructions that, when executed, cause the processor to:
receive authentication information from the financial institution computing system; and
authenticate user identification information received with a request to access the liability account.

28. The system of claim 25, wherein the financial institution computing system includes a computing device allowing access to the liability account according to two or more different access tiers, the access tiers dependent on user identification information received from the user of the self-service financial transaction device and a level of authentication of the user identification information.

29. The system of claim 28, wherein the different access tiers include at least two of the following:
a first access tier allowing access to a majority of liability account information;
a second access tier allowing partial access to liability account information, wherein the partial access corresponds information provided on a liability account statement; and
a third access tier allowing limited access to the liability account information, wherein the limited access includes applying a payment towards an outstanding balance of the liability account.

30. A method comprising:
receiving, by a computing device, a request to access to a liability account, the request including user identification information;
presenting, by a user interface, liability account information; and
receiving, by the computing device, a payment for application towards an outstanding balance of the liability account.

31. The method of claim 30, comprising authenticating, by the computing device, the user identification.

32. The method of claim 31, comprising providing access to liability account information according to one or more different access tiers, the access tiers based, at least in part, on whether the user identification was authenticated.

33. The method of claim 31, wherein authorizing, by the computing device, the user identification includes authorizing a third-party to access the liability account.

34. The method of claim 30, wherein receiving a payment includes at least one of receiving a cash deposit via an input of a self-service financial transaction device, receiving a negotiable instrument via the input of the self-service financial transaction device, and receiving an image of the negotiable instrument, the image obtained via a scanner of the self-service financial transaction device.

35. The method of claim 34, further comprising applying the payment received at the self-service financial transaction device to the outstanding balance of the liability account, wherein at least a portion of the payment received is applied in a real-time transaction.
